(19) United States
(12) Patent Application Publication
(10) Pub. No.: US 2012/0140487 A1
(43) Pub. Date: Jun. 7, 2012

(54) Lighting Apparatus

(75) Inventors: Jen-Ta Chiang, New Taipei City (TW); Chia-Hao Liang, New Taipei City (TW)

(73) Assignee: EVERLIGHT ELECTRONICS CO., LTD., New Taipei City (TW)

(21) Appl. No.: 13/372,766

(22) Filed: Feb. 14, 2012

Related U.S. Application Data
(63) Continuation of application No. 12/608,997, filed on Oct. 29, 2009, now Pat. No. 8,136,977.

(30) Foreign Application Priority Data
Oct. 30, 2008 (TW) 97141851

(51) Int. Cl. F21V 5/00; F21V 21/00

(52) U.S. Cl. 362/311.02; 362/382

(57) ABSTRACT

A lighting apparatus including a base, a circuit board, a light emitting unit, and a locking element is provided. The circuit board has a first surface and a second surface opposite to the first surface, and includes a through hole communicating the first and second surfaces. The circuit board is carried by the base with the second surface resting on the base. The light-emitting element is disposed on the first surface of the circuit board. The locking element comprises resilient hooks each of which including a resilient support, passing through the through hole with a first end of the resilient support connected to the based, and a hook head, connected to a second end of the resilient support opposite to the first end. The hook head is suitable for hooking the first surface of the circuit board.

### CROSS-REFERENCE TO RELATED APPLICATION

This application is a continuation of and claims the priority benefit of U.S. patent application Ser. No. 12/608,997, filed on Oct. 29, 2009, which claims the priority benefit of Taiwan Patent Application No. 97141851, filed on Oct. 30, 2008. The entirety of the above-mentioned patent applications are hereby incorporated by reference and made a part of this specification.

### BACKGROUND

1. Technical Field

The present invention relates to a lighting apparatus.

2. Description of Related Art

Along with the advancement of semiconductor technology, light-emitting diodes (LEDs) have achieved a higher power, emitted stronger light. Moreover, the LEDs feature various advantages, such as power saving, long service life, environmental protection, quick start-up, and small volume. Therefore, the LEDs are applied in more and more fields, such as illumination, traffic lights, displays, optical mice, and LED string lamps.

Currently, most outdoor advertisement boards use the LED string lamps as their lighting apparatus. Since an outdoor lighting apparatus must have better weatherability and waterproofness, the conventional technology is to fill the internal space of the housing of a lighting apparatus with encapsulant, so as to wrap the LED. However, in order to fill the internal space of the whole housing, a lot of encapsulant will be consumed, so it is difficult to reduce the cost of the LED string lamp, and the LED string lamp becomes heavier. Furthermore, many air bubbles will appear when the internal surface of the housing is filled by a lot of encapsulant, thereby degrading the yield of the LED string lamp. Furthermore, due to high consumption of the encapsulant, a long time period is needed before the curing of the encapsulant, resulting in difficulty in improving the production efficiency.

In addition, since the LEDs in the lighting apparatus and an external power are connected by a conducting wire, which is connected to the LEDs merely through solder joints by means of soldering, under the pulling force from the outside, the conducting wire will easily drop off from the solder joints due to the insufficient joint force, with the result that the LED string lamp cannot operate normally. In another aspect, during a manufacturing process of the conventional LED string lamp, when the encapsulant is filled into the internal space of the housing, a circuit board carrying the LEDs may float on the encapsulant, and then the LEDs cannot be completely encapsulated by the encapsulant, which degrades the yield of the LED string lamp.

### SUMMARY

Accordingly, the present invention is directed to a lighting apparatus, which has a low cost and a high manufacturing yield.

According to one aspect, a lighting apparatus may comprise a based, a circuit board, a light-emitting element, and a locking element. The circuit board may include a first surface and a second surface opposite to the first surface, and further include a through hole communicating the first surface and the second surface. The circuit board may be carried by the base with second surface resting on the base. The light-emitting element may be disposed on the first surface of the circuit board. The locking element may include a plurality of resilient hooks. Each of the resilient hooks may include a resilient support and a hook head. The resilient support may pass through the through hole with a first end of the resilient support connected to the base. The hook head may be connected to a second end of the resilient support opposite to the first end, and may be suitable for hooking the first surface of the circuit board.

In one embodiment, the resilient supports of the resilient hooks may be suitable to be bent, such that the hook heads are configured to move toward a geometric center of the hook heads.

In one embodiment, each of the hook heads may comprise a guide surface inclining with respect to the first surface and facing away from the geometric center of the hook heads.

In one embodiment, the light-emitting element may comprise a LED.

In one embodiment, the base may comprise a bottom board and a side frame. The bottom board may carry the circuit board. The locking element may be connected to the bottom board. The bottom board may include a first surface and a second surface opposite to the first surface. The side frame may be located on the first surface of the bottom board with the circuit board and the light-emitting element disposed inside the side frame.

In one embodiment, the bottom board may further comprise a recess, a first through hole, and a second through hole. The recess may be located at the second surface of the bottom board and may include a first end and a second end opposite to the first end. The first through hole may be located at the first end of the recess and may pass through the bottom board. The second through hole may be located at the second end of the recess and may pass through the bottom board. The first through hole and the second through hole may be respectively inside and outside the side frame.

In one embodiment, the lighting apparatus may further comprise a conducting wire. One end of the conducting wire may be electrically connected to the light emitting unit. The conducting wire may extend from the first surface of the bottom board to the first end of the recess through the first through hole, from the first end of the recess to the second end of the recess, and from the second end of the recess to the first surface of the bottom board through the second through hole.

In one embodiment, the lighting apparatus may further comprise an encapsulant, filled in the recess and encapsulating a part of the conducting wire in the recess.

In one embodiment, the lighting apparatus may further comprise a light transmissive lamp shade, disposed on the side frame and covering the light emitting unit. The light transmissive lamp shade may comprise a light exit surface facing away from the light emitting unit. The light exit surface may comprise a plurality of optical structures that change an emergence direction of light emitted from the light emitting unit.

In one embodiment, the side frame may comprise a first fitting portion located at one end of the side frame far away from the bottom board. The light transmissive lamp shade may comprise a second fitting portion located at one end of the light transmissive lamp shade far away from the light exit surface. The first fitting portion and the second fitting portion may fit with each other.

In one embodiment, the first fitting portion may comprise an annular protrusion, and the second fitting portion may comprise an annular depression. Alternatively, the first fitting portion may comprise an annular depression, and the second fitting portion may comprise an annular protrusion.

In one embodiment, the lighting apparatus may further comprise an encapsulant, disposed between the first fitting portion and the second fitting portion.

According to another aspect, a lighting apparatus may comprise a base, a circuit board, and a light-emitting element. The base may include a bottom board having a first surface and a second surface opposite to the first surface, a recess, located at the second surface of the bottom board and having a first end and a second end opposite to the first end, a first through hole, located at the first end of the recess and passing through the bottom board, and a second through hole, located at the second end of the recess and passing through the bottom board. The circuit board may include a first surface and a second surface opposite to the first surface, and may further include a through hole communicating the first surface and the second surface. The circuit board may be carried by the base with second surface resting on the base. The light-emitting element may be disposed on the first surface of the circuit board.

In one embodiment, the lighting apparatus may further comprise a side frame disposed on the first surface of the bottom board such that the first through hole and the second through hole may be respectively inside and outside the side frame.

In one embodiment, the lighting apparatus may further comprise a light transmissive lamp shade, disposed on the side frame and covering the light emitting unit. The light transmissive lamp shade may comprise a light exit surface facing away from the light emitting unit. The light exit surface may comprise a plurality of optical structures that change an emergence direction of light emitted from the light emitting unit.

In one embodiment, the lighting apparatus may further comprise a locking element that may comprise a plurality of resilient hooks. Each of the resilient hooks may include a resilient support and a hook head. The resilient support may pass through the through hole with a first end of the resilient support is connected to the base. The hook head may be connected to a second end of the resilient support opposite to the first end. The hook head may be suitable for hooking the first surface of the circuit board.

In one embodiment, the resilient supports of the resilient hooks may be suitable to be bent, such that the hook heads are configured to move toward a geometric center of the hook heads.

In one embodiment, each of the hook heads may comprise a guide surface inclining with respect to the first surface and facing away from the geometric center of the hook heads.

In one embodiment, the light-emitting element may comprise a LED.

In the lighting apparatus according to the embodiments of the present invention, the conducting wire extends to the recess from above the bottom board of the base to the recess through the first through hole, and extends from the recess to above the bottom board through the second through hole. When the conducting wire is pulled by an external force, the recess can bear the pulling force from the conducting wire, so as to prevent the conducting wire from dropping off form the light emitting unit. Thus, even if the conducting wire is pulled by an external force, the lighting apparatus may still operate normally. In the lighting apparatus according to the embodiments of the present invention, since the circuit board may be assembled onto the base easily by using the locking element, the circuit board will not float on the encapsulant when filling the encapsulant. In such a way, the lighting apparatus has a high manufacturing yield and efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a three-dimensional view of the lighting apparatus according to one embodiment of the present invention.

FIG. 1B is an exploded view of the lighting apparatus of FIG. 1A.

FIG. 2A is a three-dimensional view of one end of the base of FIG. 1A before filling the encapsulant.

FIG. 2B is a three-dimensional view of one end of the base of FIG. 1A after filling the encapsulant.

FIG. 3 is a schematic three-dimensional view of the circuit board assembled to the base of FIG. 1B.

### DETAILED DESCRIPTION OF PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

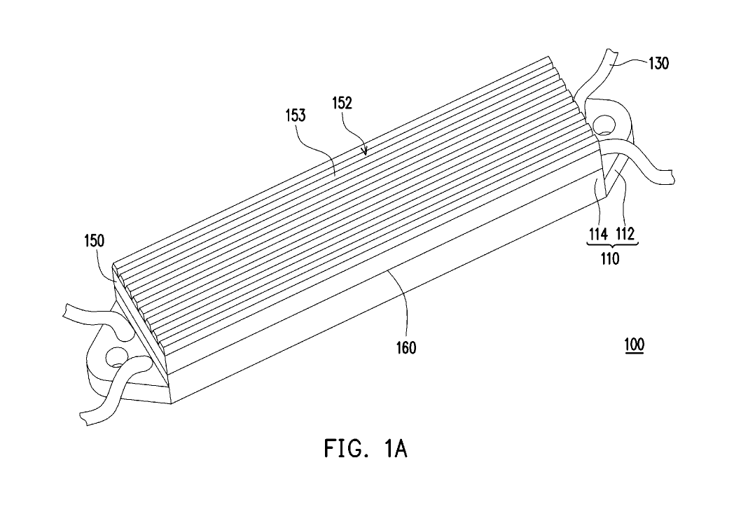

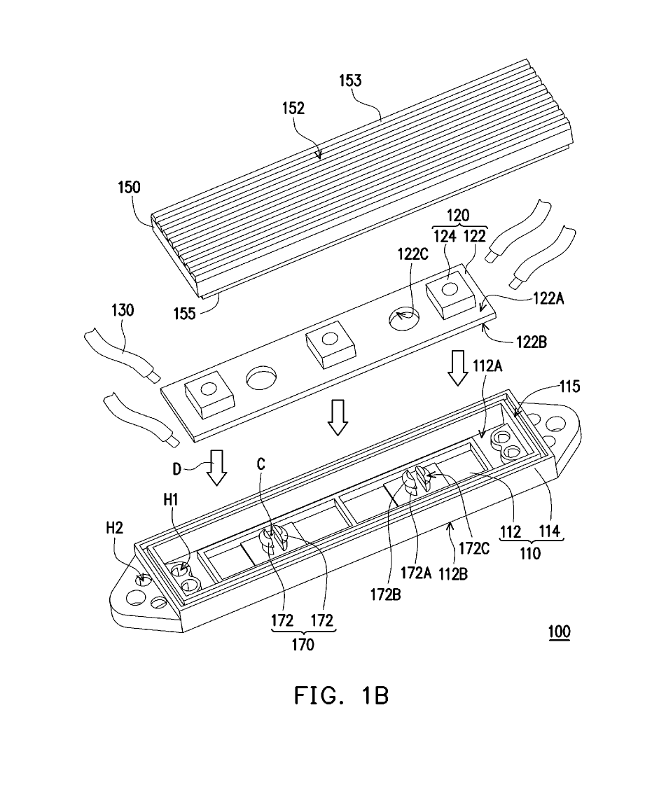

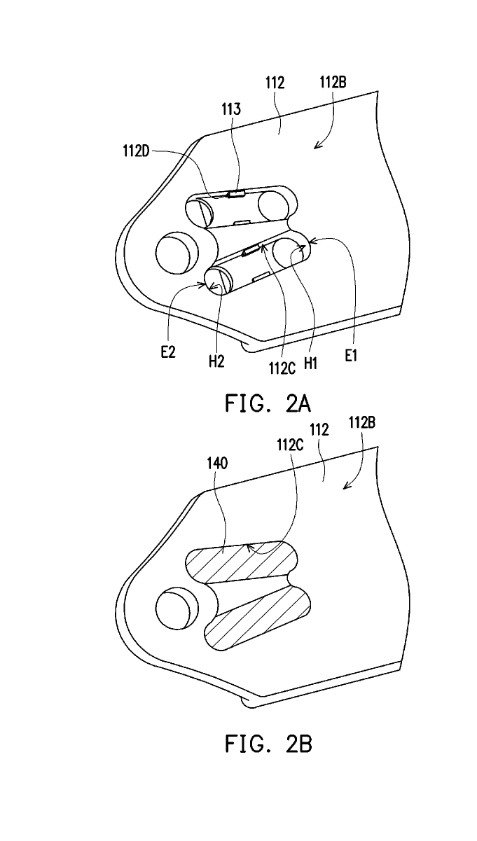

FIG. 1A is a three-dimensional view of a lighting apparatus according to one embodiment of the present invention, FIG. 1B is an exploded view of the lighting apparatus of FIG. 1A, FIG. 2A is a three-dimensional view of one end of the base of FIG. 1A before filling the encapsulant, and FIG. 2B is a three-dimensional view of one end of the base in FIG. 1A after filling the encapsulant. Referring to FIGS. 1A, 1B, and 2A, the lighting apparatus 100 according to this embodiment includes a base 110, a light emitting unit 120, and a plurality of conducting wires 130. The base 110 includes a bottom board 112 and a side frame 114. The bottom board 112 has a first surface 112A, a second surface 112B, a plurality of recesses 112C (as shown in FIG. 2A), a plurality of first through holes H1, and a plurality of second through holes H2. The second surface 112B is opposite to the first surface 112A. The recesses 112C are located on the second surface 112B, and have a first end E1 and a second end E2 opposite to the first end E1. The first through holes H1 are located at the first end E1 of the recesses 112C, and pass through the bottom board 112. The second through holes H2 are located at the second end E2 of the recess 112C, and pass through the bottom board 112. The side frame 114 is disposed on the first surface 112A, and the first through holes H1 and the second through holes H2 are respectively inside and outside the side frame 114.

The light emitting unit 120 is disposed on the first surface 112A and within the side frame 114. In this embodiment, the light emitting unit 120 includes a circuit board 122 and a plurality of LEDs 124. The circuit board 122 is disposed on the first surface 112A and inside the side frame 114, and the LED 124 is disposed on the circuit board 122. One end of the conducting wires 130 is electrically connected to the light emitting unit 120. In this embodiment, this end of the conducting wires 130 is connected to the circuit board 122. More specifically, the circuit board 122 has a third surface 122A and a fourth surface 122B opposite to the third surface 122A, this end of the conducting wire 130 may be connected to the fourth surface 122B of the circuit board 122 by soldering, and the LED 124 is disposed on the third surface 122A of the circuit board 122. However, in other embodiments, this end of the conducting wires 130 may also be connected to the third surface 122A of the circuit board 122. It should be noted that, in other embodiments, the LED 124 may also be replaced with other suitable light-emitting elements.

The conducting wire 130 extends from the first surface 112A to the first end E1 of the recess 112C through the first through hole H1 (as shown in FIG. 2A), extends from the first end E1 to the second end E2, and extends from the second end E2 to the outer side of the first surface 112A through the second through hole H2. In this embodiment, the lighting apparatus 100 further includes an encapsulant 140 (as shown in FIG. 2B), which is filled into the recess 112C, and encapsulates the part of the conducting wire 130 in the recess 112C. In addition, the bottom board 112 further includes two hooks 112D, which are located in the recess 112C and at the two opposite sides of the conducting wire 130. Hook heads 113 of the hooks 112D are located at the top of the recess 112C to hook the conducting wire 130.

In the lighting apparatus 100 according to this embodiment, the conducting wires 130 extend from above the first surface 112A of the bottom board 112 to the recesses 112C at the second surface 1128 through the first through holes H1, and from the recesses 112C to above the first surface 112A through the second through holes H2. When the conducting wires 130 are pulled by an external force, the recesses 112C can bear the pulling force of the conducting wire 130, so as to prevent the junctions of the conducting wires 130 and the circuit board 122 from being under stress directly and dropping off. Thus, even if the conducting wires 130 are pulled by an external force, the lighting apparatus 100 may still operate normally. Furthermore, the hooks 112D are helpful for fixing the position of the conducting wires 130. Therefore, when the conducting wires 130 are pulled by an external force, the tensile force on the conducting wires 130 is less likely to be transferred to the junctions between the conducting wires 130 and the circuit board 122.

In this embodiment, the lighting apparatus 100 further includes a lamp shade 150 disposed on the side frame 114 and covering the light emitting unit 120. The light transmissive lamp shade 150 has a light exit surface 152 facing away from the light emitting unit 120, and the light exit surface 152 has a plurality of optical structures 153 for changing the emergence direction of light emitted from the light emitting unit 120. More specifically, the optical structures 153 may be, for example, strip-shaped protrusions. However, in other embodiments, the optical structures 153 may also be spot-shaped protrusions, bump-shaped protrusions, spot-shaped recesses, bump-shaped recesses, strip-shaped recesses, or optical structures of other forms. Thus, when the user has different requirements for the light shapes of the lighting apparatus 100, the lamp shade 150 having different optical structures 153 may be changed to meet the requirements, and it is unnecessary to change the light emitting unit 120 or the LED 124.

In this embodiment, the side frame 114 has a first fitting portion 115 located at one end of the side frame 114 far away from the bottom board 112, and the light transmissive lamp shade 150 has a second fitting portion 155 located at one end of the light transmissive lamp shade 150 far away from the light exit surface 152. The first fitting portion 115 and the second fitting portion 155 fit with each other. More specifically, for example, the first fitting portion 115 is an annular depression, the second fitting portion 155 is an annular protrusion, and the second fitting portion 155 is embedded into the first fitting portion 115. However, in other embodiments, the first fitting portion 115 may also be an annular protrusion, and the second fitting portion 155 may also be an annular depression. In this embodiment, the lighting apparatus 100 further includes an encapsulant 160 (as shown in FIG. 1A) disposed between the first fitting portion 115 and the second fitting portion 155.

The lighting apparatus 100 according to this embodiment has better weatherability and waterproofness just because of the encapsulant 140 disposed in the recesses 112C and the encapsulant 160 disposed between the first fitting portion 115 and the second fitting portion 155, and it is unnecessary to fill the whole internal space formed by the base 110 and the light transmissive lamp shade 150 with the encapsulant. In such a manner, the lighting apparatus 100 can have a light weight and a low cost, and the yield reduction caused by air bubbles in the encapsulant filled in the internal space is prevented.

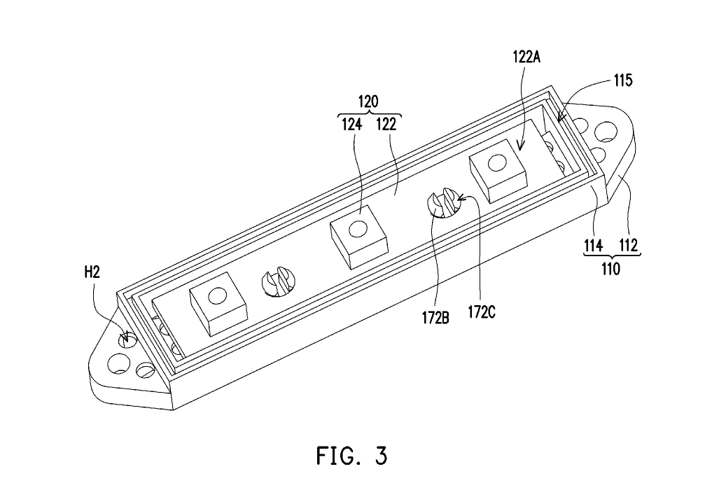

In this embodiment, the circuit board 122 has a plurality of through holes 122C communicating the third surface 122A and the fourth surface 122B. Furthermore, the base 110 carries the circuit board 122, and the fourth surface 122B of the circuit board 122 rests on the base 110. In this embodiment, the lighting apparatus 100 further includes a plurality of locking elements 170, and each of the locking elements 170 includes a plurality of resilient hooks 172. Each of the resilient hooks 172 includes a resilient support 172A and a hook head 172B. The resilient supports 172A pass through the through holes 122C. In other words, the locking elements 170 pass through the through holes 122C respectively. Furthermore, one end of the resilient support 172A is connected to the base 110. More specifically, one end of the resilient support 172A may be connected to the bottom board 112 of the base 110. The hook head 172B is connected to the other end of the resilient support 172A, and the hook head 172B is suitable for hooking the third surface 122A of the circuit board 122, as shown in FIG. 3.

In this embodiment, the resilient supports 172A of the resilient hooks 172 are suitable to be bent, such that the hook heads 172B move toward a geometric center C of the hook heads 172B (as shown in FIG. 1B). Furthermore, in this embodiment, each of the hook heads 172B has a guide surface 172C, which inclines with respect to the third surface 122A of the circuit board 122, and faces away from the geometric center C of the hook heads 172B. In order to assemble the circuit board 122 onto the base 110, it is only necessary to press the circuit board 122 toward the base 110 along a direction D, so that the edge of the through holes 122C pushes the guide surface 172C. Thus, the hook heads 1728 move toward the geometric center C of the hook heads 172B, such that the resilient supports 172A are inserted into the through holes 122C, thereby finishing the assembly of the circuit board 122. Therefore, in the lighting apparatus 100 according to this embodiment, the circuit board 122 and the base 110 may be assembled easily, so as to reduce the cost and shorten the working hours.

It should be noted that, the present invention does not limit that the locking elements 170 are applied in the lighting apparatus 100 having the recesses 112C and the encapsulant 160. In other embodiments that are not shown, the locking elements 170 may also be applied on the lighting apparatus having an internal space formed by the base and the light transmissive lamp shade filled with the encapsulant. Since the locking elements 170 may lock the circuit board on the base, the circuit board will not float on the encapsulant in the manufacturing process. Therefore, the manufacturing yield of the lighting apparatus will not be reduced.

In view of the above, in the lighting apparatus according to the embodiments of the present invention, the conducting wires extend from above the bottom board of the base to the recesses through the first through holes, and extend from the recesses to above the bottom board through the second through holes. When the conducting wires are pulled by an external force, the recesses may bear the pulling force from the conducting wires, so as to prevent the conducting wires from dropping off from the light emitting unit. Thus, even if the conducting wires are pulled by an external force, the lighting apparatus may still operate normally.

In addition, in the lighting apparatus according to the embodiments of the present invention, since the encapsulant is merely located in the recesses and between the first fitting portion and the second fitting portion, the lighting apparatus may have a light weight and a low cost, and no air bubbles will appear in the encapsulant to affect the light shape and lighting efficiency of the lighting apparatus.

Furthermore, in the lighting apparatus according to the embodiments of the present invention, since the circuit board may be assembled onto the base easily by using the locking element, the circuit board will not float on the encapsulant when filling the encapsulant. Thus, the lighting apparatus may have a high manufacturing yield and manufacturing efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lighting apparatus, comprising:
a base;
a circuit board, having a first surface and a second surface opposite to the first surface, and having a through hole communicating the first surface and the second surface, the circuit board carried by the base with second surface resting on the base;
a light-emitting element, disposed on the first surface of the circuit board; and
a locking element, comprising a plurality of resilient hooks, each of the resilient hooks comprising:
a resilient support, passing through the through hole, wherein a first end of the resilient support is connected to the base; and
a hook head, connected to a second end of the resilient support opposite to the first end, wherein the hook head is suitable for hooking the first surface of the circuit board.

2. The lighting apparatus according to claim 1, wherein the resilient supports of the resilient hooks are suitable to be bent, such that the hook heads are configured to move toward a geometric center of the hook heads.

3. The lighting apparatus according to claim 2, wherein each of the hook heads comprises a guide surface inclining with respect to the first surface and facing away from the geometric center of the hook heads.

4. The lighting apparatus according to claim 1, wherein the light-emitting element comprises a light-emitting diode (LED).

5. The lighting apparatus according to claim 1, wherein the base comprises:
a bottom board, carrying the circuit board, wherein the locking element is connected to the bottom board, the bottom board having a first surface and a second surface opposite to the first surface; and
a side frame, located on the first surface of the bottom board, wherein the circuit board and the light-emitting element are inside the side frame.

6. The lighting apparatus according to claim 5, wherein the bottom board further comprises:
a recess, located at the second surface of the bottom board and including a first end and a second end opposite to the first end;
a first through hole, located at the first end of the recess and passing through the bottom board; and
a second through hole, located at the second end of the recess and passing through the bottom board,
wherein the first through hole and the second through hole are respectively inside and outside the side frame.

7. The lighting apparatus according to claim 6, further comprising:
a conducting wire, wherein one end of the conducting wire is electrically connected to the light emitting unit, and wherein the conducting wire extends from the first surface of the bottom board to the first end of the recess through the first through hole, from the first end of the recess to the second end of the recess, and from the second end of the recess to the first surface of the bottom board through the second through hole.

8. The lighting apparatus according to claim 6, further comprising an encapsulant, filled in the recess and encapsulating a part of the conducting wire in the recess.

9. The lighting apparatus according to claim 5, further comprising:
a light transmissive lamp shade, disposed on the side frame and covering the light emitting unit, wherein the light transmissive lamp shade comprises a light exit surface facing away from the light emitting unit, and wherein the light exit surface comprises a plurality of optical structures that change an emergence direction of light emitted from the light emitting unit.

10. The lighting apparatus according to claim 9, wherein the side frame comprises a first fitting portion located at one end of the side frame far away from the bottom board, wherein the light transmissive lamp shade comprises a second fitting portion located at one end of the light transmissive lamp shade far away from the light exit surface, and wherein the first fitting portion and the second fitting portion fit with each other.

11. The lighting apparatus according to claim 10, wherein the first fitting portion comprises an annular protrusion, and wherein the second fitting portion comprises an annular depression.

12. The lighting apparatus according to claim 10, wherein the first fitting portion comprises an annular depression, and wherein the second fitting portion comprises an annular protrusion.

13. The lighting apparatus according to claim 10, further comprising:
an encapsulant, disposed between the first fitting portion and the second fitting portion.

14. A lighting apparatus, comprising:
a base, including:
a bottom board having a first surface and a second surface opposite to the first surface,
a recess, located at the second surface of the bottom board and having a first end and a second end opposite to the first end,
a first through hole, located at the first end of the recess and passing through the bottom board, and
a second through hole, located at the second end of the recess and passing through the bottom board;
a circuit board, having a first surface and a second surface opposite to the first surface, and having a through hole communicating the first surface and the second surface, the circuit board carried by the base with second surface resting on the base; and
a light-emitting element, disposed on the first surface of the circuit board.

15. The lighting apparatus according to claim 14, further comprising:
a side frame, disposed on the first surface of the bottom board, wherein the first through hole and the second through hole are respectively inside and outside the side frame.

16. The lighting apparatus according to claim 15, further comprising:
a light transmissive lamp shade, disposed on the side frame and covering the light emitting unit, wherein the light transmissive lamp shade comprises a light exit surface facing away from the light emitting unit, and wherein the light exit surface comprises a plurality of optical structures that change an emergence direction of light emitted from the light emitting unit.

17. The lighting apparatus according to claim 14, further comprising:
a locking element, comprising a plurality of resilient hooks, each of the resilient hooks comprising:
a resilient support, passing through the through hole, wherein a first end of the resilient support is connected to the base; and
a hook head, connected to a second end of the resilient support opposite to the first end, wherein the hook head is suitable for hooking the first surface of the circuit board.

18. The lighting apparatus according to claim 17, wherein the resilient supports of the resilient hooks are suitable to be bent, such that the hook heads are configured to move toward a geometric center of the hook heads.

19. The lighting apparatus according to claim 18, wherein each of the hook heads comprises a guide surface inclining with respect to the first surface and facing away from the geometric center of the hook heads.

20. The lighting apparatus according to claim 14, wherein the light-emitting element comprises a light-emitting diode (LED).
